(19) United States
(12) Patent Application Publication
(10) Pub. No.: US 2013/0167025 A1
(43) Pub. Date: Jun. 27, 2013

(54) SYSTEM AND METHOD FOR ONLINE USER ASSISTANCE

(71) Applicants: Vinay Kumar Patri, Chennai (IN); Rajesh Saravanan, Chennai (IN)

(72) Inventors: Vinay Kumar Patri, Chennai (IN); Rajesh Saravanan, Chennai (IN)

(73) Assignee: TATA CONSULTANCY SERVICES LIMITED, Mumbai (IN)

(21) Appl. No.: 13/398,926

(22) Filed: Feb. 17, 2012

(30) Foreign Application Priority Data
Dec. 27, 2011 (IN) 3675/MUM/2011

(51) Int. Cl. G06F 3/048

(52) U.S. Cl. 715/706

(57) ABSTRACT

The present invention relates to a system and method for assisting online users through a computer generated human-like animated character. Further, the invention provides the method for enabling the said human-like animated character for intuitively responding to user queries. The present invention provides automated answers of the said user queries by mining the data from a real-time updatable database displayed on the screen or display.

### FIELD OF THE INVENTION

The invention relates to the field of computer graphics based animation. More particularly the present invention relates to a system and method for providing an online audio-visual assistance to a user through a human-like animated character.

### BACKGROUND OF THE INVENTION

Assisting online users over a website or otherwise with an animated character is a user-friendly technique for guiding the user by facilitating necessary details in order to successfully perform a complex business transaction or process online. While processing or seeking information over a website, users are frequently dropped-out from web-pages or web based applications resulting in a sequential loss and wastage of time and business. The user thus requires a step-wise guidance for successfully completing the business transaction or process. Such online assistance is generally provided in an audio-visual form by the said computer generated animated characters. The online assistance provided to the user brings them to an immense satisfaction as they are able to hear and visualize the answers of their query automatically with the help of the said animated character.

Use of these animated characters is known for assisting the online users, mostly for the websites and online portals. When the user comes across to an existing or a new business process over the websites to which he/she is not aware of, then such animated characters makes it easier and convenient to the user to receive a proper guidance on the screen or display terminals.

One of the known methods for providing an online assistance is guidance to the user through the computer generated animated character, where the said animated characters are capable for assisting the user with preconfigured answers of frequently asked queries related to that business transaction. However, such methods are limited to a particular set of queries which are pre-stored in the database and mapped to their respective answers. Moreover, the animated character remains stationary at a particular position on the screen or the display from where it assists the user using props or written messages. Thus in the prior art there is a lack of ability for virtual movement of such animated character to specific location(s) of the details or the answers which are displayed or can be displayed on the screen.

Hence the lack of virtual movement of the animated character to a specific location on the display or screen still remains a need in the art. Moreover, yet another issue related to ability of the said animated character to assist the user intuitively on the basis of artificial intelligence is an unaddressed problem in the art. So, there is a long felt need for a system and method for providing the advanced audio visual online assistance to the user using an intuitively responsive human-like animated character.

### OBJECTS OF THE INVENTION

The primary objective of a present invention is to provide a system and method that enables integration of a computer generated human-like animated character with user queries to assist an online user in finding out appropriate answers therefor using underlying rules engine and a knowledge database in an intelligent manner.

Another object of the present invention is to provide a system and method for providing an audio-visual assistance to the online users using the said human-like animated character which is a programmed interface enabled for quick identification of user queries in a given functional context.

Yet another object of the present invention is to enable the said human-like animated character to virtually walk down to specific location(s) of identified relevant information either displayed or can be displayed on such screen.

Yet another object of the present invention is to enable the method and system for assisting the online users by providing automated answers mined from a real-time training simulation database backed by artificial intelligence.

### SUMMARY OF THE INVENTION

Before the present system and method, enablement are described, it is to be understood that this invention is not limited to the particular system, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present invention.

The present invention introduces a system and method for providing an online audio-visual assistance to a user through a computer generated human-like animated character. The said human-like animated character is configured for responding with the cognitive data on the basis of artificial intelligence upon processing the user entered queries in a real-time. On the basis of the context of the queries, the said human-like animated character is further configured for defining different gestures and linking each such gesture with the context of the query for assisting and guiding the user by virtually walking across specific locations of displayed information on screen.

In one aspect of the invention the system receives the user query through an input means. The received query as an input can be in a text or voice format. After receiving the query, the input means transmits the data to a remotely located web server where such query is further processed. If the query is the voice format, then the remotely placed web server converts the query into text format using speech-to-text processor in order to further perform text based analytics. The said text analytics based on the artificial intelligence is performed by mining such queries in a preconfigured real-time training simulation database which is stored in a memory of the said web server. With the help of natural language processing and expert systems, the said web server searches and identifies the relevant information and their specific location(s) and travel paths on the display screen. A plurality of historical learning's associated with the identified relevant information is consolidated for providing an audio-visual virtual assistance to the user by converting the consolidated historical learning variables into a speech output and spontaneously synchronizing it with the said human-like animated character. A text-to-speech processor of the said web server is configured for converting the identified relevant information and their specific locations into a voice output providing audio-visual assistance to the user. The said human-like animated character virtually guides the user like a real-life interaction. Control algorithm and rule engine of the said web server are configured for providing a set of instructions to the human-like animated character for directing it to virtually move on the screen. The said sets of instructions are stored in the memory of the rules engine.

On the basis of the context of the query with its corresponding relevant information with its specific locations, the movement of the human-like animated character is decided with a spontaneously determined one or more travel paths of the specific locations of the identified relevant information. Therefore the human-like animated character is directed for spontaneously initiating a planar movement based on a contextually determined one or more travel path displayed on the screen or display Thus, the said human-like animated character guides the user intuitively by physically moving and semantically positioning itself to the one or more specific locations of the displayed relevant information on the screen.

In another aspect the invention the system for providing the audio-visual assistance to the online users based on the artificial intelligence by using the human-like animated character comprises of:

one or more communication devices wirelessly connected by the means of wireless communication with the remotely located web server. The said communication device(s) further comprises:

a display and an input means, whereas the remotely located web server comprises of the data processing unit and a text-to-speech processor.

The said data processing unit comprises an expert system and a rule engine that is interfaced with each other through an expert system interface and control algorithm respectively. The said expert system is coupled with the knowledge database, wherein the said knowledge database is configured for real-time training simulation on the basis of historical learning. The said rule engine is coupled with the behavior rules database, wherein the behavior rules database is also configured for real-time simulation on the basis of historical learning. Thus the said system is configured for assisting and guiding the user in the real-time, artificial intelligence based responses through human-like animated character on the basis of historical learning, wherein the said human-like animated character is configured for virtually walking down to the specific location(s) of the identified relevant information.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings various stages of the invention; however, the invention is not limited to the specific system components and methods disclosed in the drawings.

FIG. 1 is the block diagram of the system (100) illustrating the multiple embodiments of the present invention.

FIG. 2A and 2B is the illustration of the user assistance method (200) and (300) respectively using a human-like animated character according to one aspect of the present invention.

FIG. 3A and 3B is the illustration of a user assistance method (400) and (500) respectively using the human-like animated character according to another aspect of the present invention.

### DETAILED DESCRIPTION OF THE INVENTION

The invention will now be described with respect to various embodiments. The following description provides specific details for understanding of, and enabling description for, these embodiments of the invention. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The invention generally provides a system and method for assisting online users in real-time with artificial intelligence based responses through a computer generated human-like animated character, characterized by enabling the said human-like animated character to virtually walk down the user to specific location(s) of displayed relevant information on a screen.

In an embodiment of the invention the system comprises a communication device wirelessly connected to a remotely located web server, wherein the said communication device further comprises of a display and an input means.

The input means is capable for receiving user queries in a text format, voice format or a combination thereof. After receiving the queries from the user, the input means transmits the received query to the said remotely located web server, wherein the content of the received query is brought in an appropriate format.

The present invention also enables the user to familiarize with a process. The human-like animated character can actually click open specific tabs and hyperlinks on the web pages narrating the action and subsequent result. On the basis of the context of the queries, the said human-like animated character is configured for defining different gestures and linking each gesture with the contexts of the queries for virtually assisting and guiding the user for successfully performing a business transaction or process. If the received query is in the voice format then with the help of speech-to-text processor, it is converted into the text format and then the web server proceeds for executing text analytics. The expert system and natural language processor embedded within the web server executes the text analytics by searching and identifying the relevant information with their specific locations based on the given queries from a preconfigured real-time training simulation database, wherein the said preconfigured real-time simulation database is stored in memory of the web server. It should be noted that the user is also allowed to provide and receive his queries processed in a real-time as the input after text analytics is taken as a search on the said preconfigured real-time training simulation database.

The identified relevant information and their specific locations are then processed through a text-to-speech processor. The converted format i.e., the speech format of the identified relevant information and their specific locations are then spontaneously synchronized with the human-like animated character.

The said human-like animated character driven by artificial intelligence is further capable for elaborating the details of the identified relevant information located on the web page. The said human-like animated character guides and allows the user to decide and select available options and sequentially displays relevant information over the web page. Further, on the basis of the selected options by the user, the said human-like animated character responds and guides the user like a real-life interaction.

The movement, actions and expressions of the human-like animated character are controlled by control algorithms and rule engine embedded within the web server.

The said control algorithm and rule engine provides a set of processor implemented instructions to the human-like animated character for directing it to virtually move across the screen or the display over the web page with different actions, expressions and mood, wherein the said set of instructions are based on the identified relevant information and their specific locations. On the basis of the query, the said control algorithms and rule engine also determines the one or more travel path and coordinates for the specific locations of the relevant information and simultaneously maps the coordinates with the said human-like animated character. Thus, the said human-like animated character driven by artificial intelligence guides the user audibly and visually by virtually moving or walking down the user along with the spontaneously determined travel path to the specific location of the displayed relevant information on the screen for successfully performing the said business transaction or process.

Next, the preferred embodiments of the present invention will be described below based on drawings.

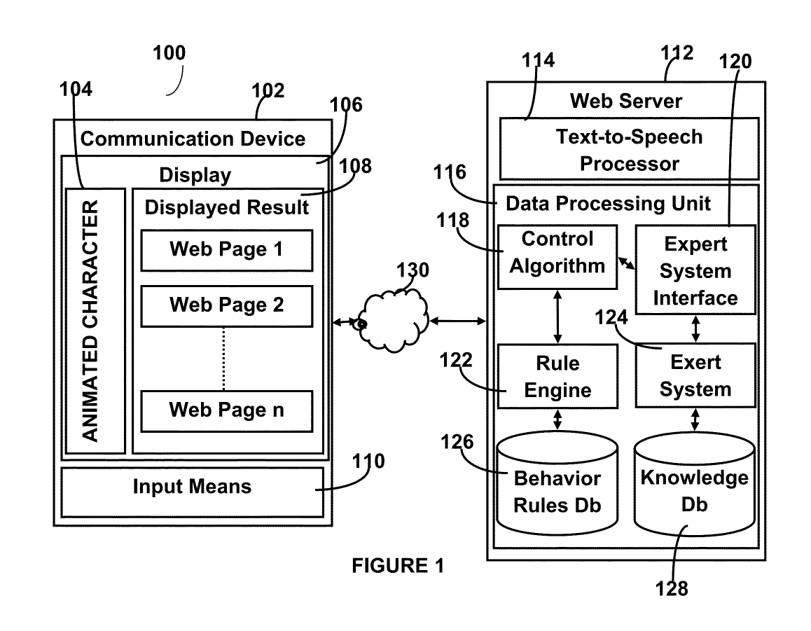

FIG. 1 is the block diagram of a system (100) illustrating the multiple embodiments of a present invention. The system (100) comprises of a communication device, hardware (102) wirelessly connected to a remotely located web server, hardware (112). The said communication device (102) further comprises of a display (106) and an input means (110) whereas the web server (112) comprises of a text-to-speech processor (114) and a data processing unit (116). The said communication device (102) is configured for receiving a user query as an input through the input means (110) and further transmitting it to the remotely located web server (112). The received query could be in a text format, voice format or combination thereof. In the case where the query is in a voice format, a speech-to-text processor (not shown in the figure) embedded within the web server (112) converts the format of the query from voice to text. The data processing unit (116) embedded within the web server (112) is configured for performing text analytics on the converted query in the text format. An expert system (124) using a natural language processing executes the text analytics on the query by selecting the keywords from the context of the query and conducting a search using artificial intelligence in one of the preconfigured real-time training simulation database i.e., knowledge database (128) stored in memory of the web server (112). The said knowledge database (128) updates its information on the basis of historical learning. While conducting the search, the said expert system (124) further process the selected keywords from the context of the query against some predefined business rules of a business process which are stored in an another type of real-time training simulation database i.e., behavior rules database (126) of the web server (112) resulting in a relevant information and their specific locations identified over a web page during the search.

The identified relevant information and their specific locations are then processed through the text-to-speech processor (114). The converted speech format of the identified relevant information and their specific locations are then spontaneously synchronized with the said human-like animated character (104). The said human-like animated character (104) is further configured for speaking out the identified relevant information and virtually guiding the user for successfully performing the said business transaction on the screen.

The said control algorithm (118) and the rule engine (122) provides a set of instructions to the said human-like animated character (104) for directing it to virtually move across the display (108) with different actions, expressions and mood, wherein the said set of instructions are based on the identified relevant information with their specific locations located on the web page. Also, the human-like animated character (104) driven by artificial intelligence is configured for guiding the user by displaying the available options and details of the displayed relevant information and allowing the user to decide and select one or more said available options by the means of the said input means (110). On the basis of the selected options by the user, the said human-like animated character (104) using artificial intelligence virtually responds and guides the user like a real-life interaction.

On the basis of the query, the said control algorithm (118) and rule engine (122) determines the travel path and coordinates of the specific locations of the relevant information and simultaneously maps the coordinates with the said human-like animated character (104). In an another scenario, the said rule engine (122) and the control algorithm (118) determines the travel path and coordinates of the specific locations of the relevant information on the basis of the user selected options which are displayed with at least one relevant information on the screen. Thus, the said human-like animated character (104) guides the user by virtually moving or walking down the user along with the spontaneously determined travel path to the specific locations of the displayed relevant information on the display (106).

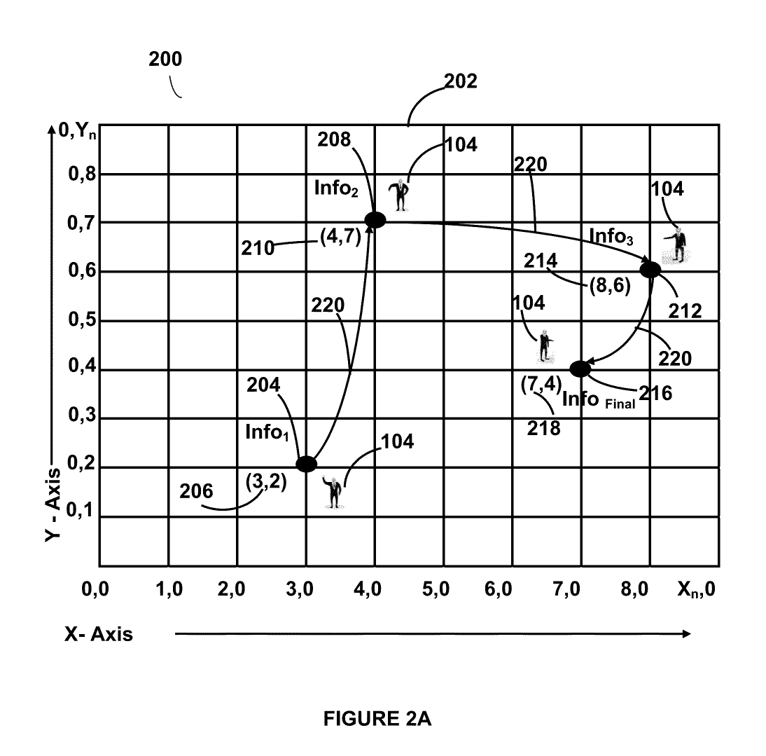

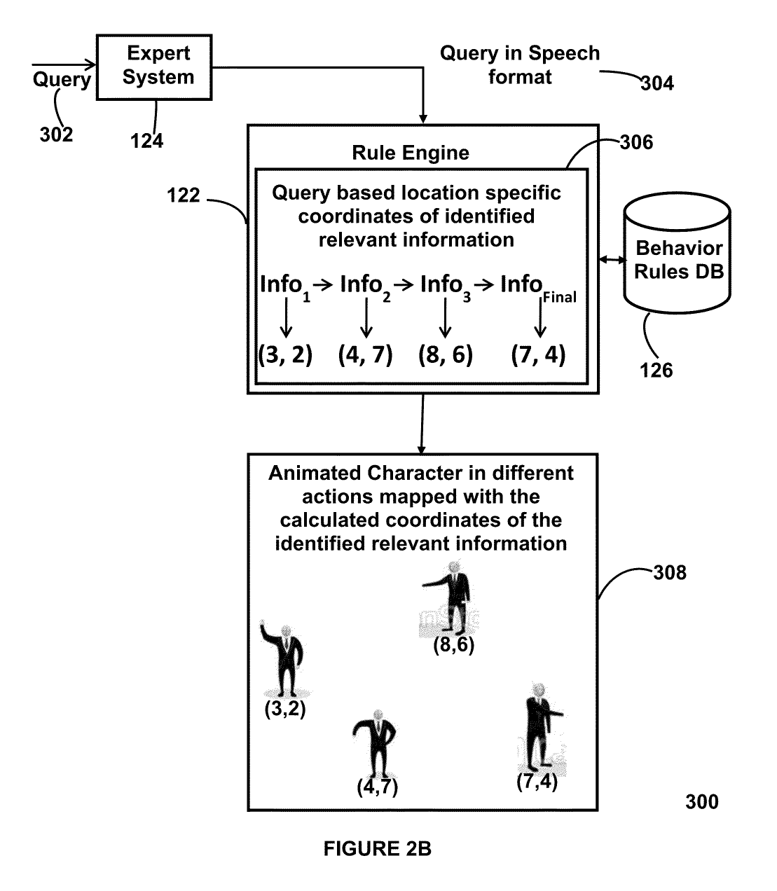

FIG. 2A and 2B is the illustration of the user assistance method (200) and (300) respectively using a human-like animated character according to one aspect of the present invention. The said user assistance method (200) displays a web page (202) comprising of specific location(s) of identified relevant information and a computer generated human-like animated character (104). An expert system (124 of FIG. 2B) receives the query (302) from the user and using a natural language processing it performs a text analytics on the received query (302). The received query can be in a text or voice format. If the received query is in voice format then a text-to-speech processor (not shown in the figure) converts the format of the query from voice to text. Further, the said expert system (124 of FIG. 2B) identifies the relevant information with their specific locations which are further displayed over the web page (202) on the display or screen. The identified relevant information over the web page (202) can be in a form of a text or a web element. Further, the identified relevant information with their specific locations is then processed through the text-to-speech processor (114) and the query in speech format (304 of FIG. 2B) is passed to the rule engine (122 of FIG. 2B). The converted speech format of the identified relevant information and their specific locations are then spontaneously synchronized with the said human-like animated character (104). The artificially driven human-like animated character (104) is further configured of speaking out the identified relevant information and guiding and allowing the user to select one or more available options displayed with the identified relevant information for successfully performing a business transaction or a process over the web page (202) displayed on the screen.

Further, the rule engine (122 of FIG. 2B) along with the control algorithm determines the travel path (220 of FIG. 2A) and coordinates of the specific locations of the identified relevant information and simultaneously maps the coordinates (306 of FIG. 2B) with the said human-like animated character (104). Yet, in an another scenario, the rule engine (122 of FIG. 2B) along with the control algorithm is configured for directing the said human-like animated character to determine the travel path (220) from one relevant information to the another sequenced relevant information on the basis of options selected by the user and responding accordingly. The said human-like animated character (104) automatically converts into gestures in accordance with calculated coordinates over the web page (202) of the specific locations of the identified relevant information displayed on screen or display. The human-like animated characters (104) in different actions and expressions are sequentially mapped with the calculated coordinates of the identified relevant information (308 of FIG. 2B). The sequentially mapped calculated coordinates of the specific locations of the identified relevant information are displayed on the web page (202).

As shown in FIG. 2A, the human-like animated character (104) guides the user for successfully performing the business transaction or process, starting from first information [Info₁] (204) which is mapped with the calculated coordinates [3,2] (206) over the web page (202) and sequentially follows the travel path (220) via second information [Info₂ ] (208) and third information [Info₃ ] (212) to final information [Info_{Final} ] (216) which is mapped with the calculated coordinates [7,4] (218) over the displayed web page (202). Also, the generated human-like animated character (104) automatically detects itself whether it's hiding or standing in front of or hindering the display of any web elements on the screen. Further, it should be noted that, that there could be n number of specific locations depending upon the identified relevant information upon which the said human-like animated character (104) will be capable for guiding the user over the displayed web page (202). Thus, the said human-like animated character (104) driven by artificial intelligence, audio-visually guides the user by virtually moving or walking down the user along with the spontaneously determined travel path (220) to the specific locations of the displayed relevant information over the web page (202) on the display.

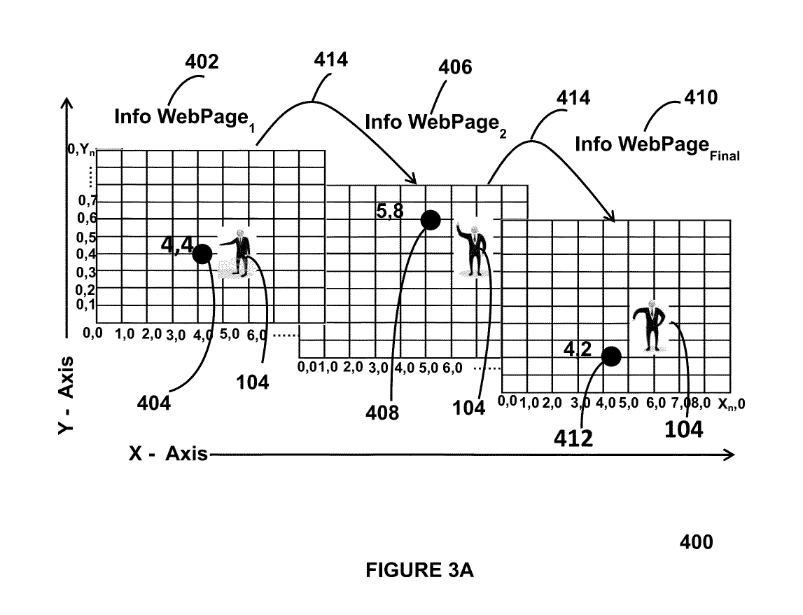

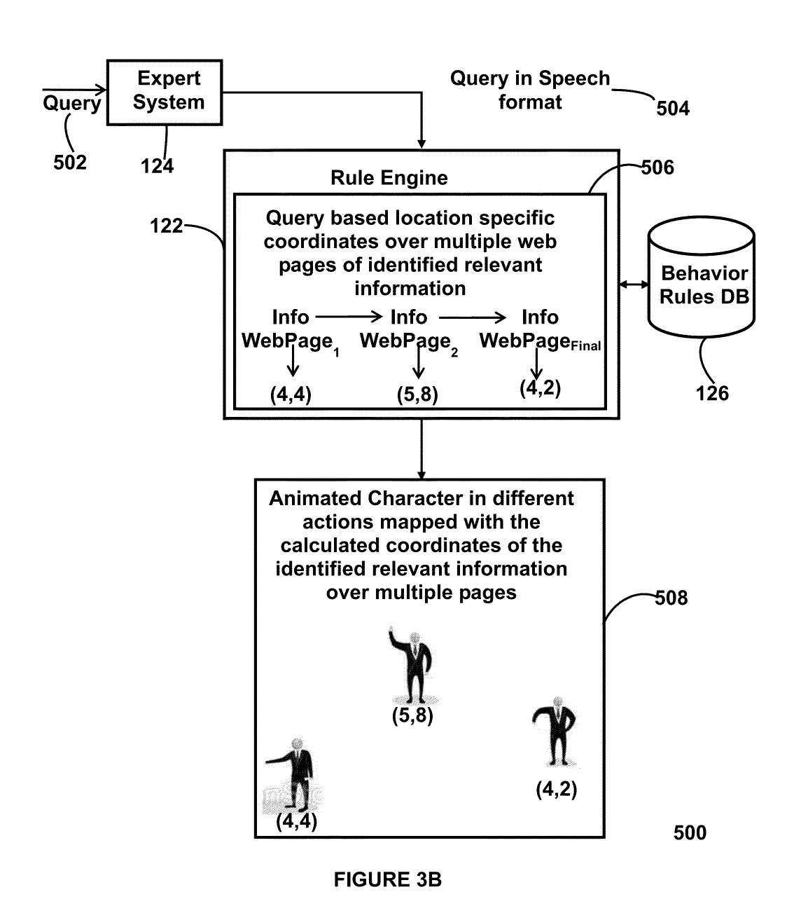

FIG. 3A and 3B is the illustration of a user assistance method (400) and (500) respectively using the human-like animated character according to another aspect of the present invention. According to this aspect of the present invention, relevant information and their specific locations can be identified over multiple web pages as shown in the FIG. 3A.

In this case, the user assistance method (400) displays three web pages uploaded sequentially with the identified relevant information and their specific locations.

Here, an expert system (124 of FIG. 3B) receives the query (502) from the user and using a natural language processing it performs the text analytics on the received query (502). The received query can be in a text or voice format. If the received query is in voice format then a text-to-speech processor (not shown in the figure) converts the format of the query from voice to text. Further, the said expert system (124 of FIG. 3B) identifies the relevant information with their specific locations which are sequentially uploaded and displayed on screen. The identified relevant information over the said multiple web pages can be in a form of a text or a web element. Further, the identified relevant information with their specific locations is then processed through the text-to-speech processor (114) and the query in speech format (504 of FIG. 3B) is passed to the rule engine (122 of FIG. 3B). The converted speech format of the identified relevant information and their specific locations are then spontaneously synchronized with the said human-like animated character (104). Then the human-like animated character (104) driven by artificial intelligence is further configured for speaking out the identified relevant information and guiding the user allowing them to select one or more available options displayed with the identified relevant information for successfully performing a business transaction or a process over the said sequentially uploaded multiple web pages displayed on the screen.

Further, the rule engine (122 of FIG. 3B) along with the control algorithm determines the travel path (414 of FIG. 3A) and coordinates of the specific locations of the relevant information and simultaneously maps the coordinates (506 of FIG. 3B) with the said human-like animated character (104). In an another scenario, the said rule engine (122 of FIG. 3B) along with the control algorithm is configured for directing the said human-like animated character (104) to determine the travel path from one relevant information to the another sequenced relevant information which is uploaded with the next web page on the basis of the options selected by the user. The said human-like animated character (104) automatically converts into gestures in accordance with the identified coordinates of the specific locations of the identified relevant information over the said sequentially uploaded multiple web pages displayed on the screen or display. The human-like animated characters (104) in different actions are accordingly mapped with the calculated coordinates of the identified relevant information over the multiple web pages (508). The calculated coordinates for the specific locations of the identified relevant information are displayed on the said sequentially uploaded multiple web pages i.e., (402), (406) and (410) on the screen or display.

As shown in FIG. 3A, the human-like animated character (104) audio-visually guides the user for successfully performing the said business transaction or process, starting from the specific location of the identified relevant information of the first web page i.e., [Info WebPaged₁] (402) which is mapped with the calculated coordinates at [4,4] (404) over the said first web page (402) and sequentially follows the spontaneously determined travel path (414) via second web page [Info Webpage₂] (406) to the final web page [Info WebPage_{Final}] (410) displaying the identified final relevant information which is mapped with the calculated coordinates [4,2] (412) displayed on the screen or display. Also, the generated human-like animated character automatically detects itself whether it's hiding or standing in front of or hindering the display of any web elements on the screen. The said human-like animated character also capable for adjusting its position without compromising with the gesture it has to perform, such as pointing towards an area of information displayed on the display or screen. Further, it should be noted that, that there could be n number of web pages and their specific locations depending upon the identified relevant information upon which the said human-like animated character (104) will be capable for guiding the user over the displayed multiple web pages. Thus, the present invention according to this aspect directs the human-like animated character (104) which is artificially driven for guiding the user audibly and visually by virtually moving or walking down the user along with the said spontaneously determined travel path to the specific locations of the displayed identified relevant information over the sequentially uploaded multiple web pages on the display.

In accordance with various embodiments of the present disclosure, the methods described herein are intended for operation as software programs running on a computer processor.

The illustrations of arrangements described herein are intended to provide a general understanding of the structure of various embodiments, and they are not intended to serve as a complete description of all the elements and features of methods and system that might make use of the structures described herein.

Although the invention has been described in terms of specific embodiments and applications, persons skilled in the art can, in light of this teaching, generate additional embodiments without exceeding the scope or departing from the spirit of the invention described herein.

We claim:

1. A method for assisting a user with an intuitively responsive virtual animated character to a one or more queries of the user, the said method comprises:
a. configuring the virtual animated character by defining a plurality of predefined gestures set for the character and linking each gesture with one or more contexts associated therewith the query;
b. receiving the query from the user in at least one format through an input means;
c. converting the input to at least one appropriate format and running at least one APIs to activate the preconfigured virtual animated character;
d. searching and identifying a specific location of information relevant to the query in a pre-configured real time updatable information database;
e. consolidating a plurality of variable of historical learning associated with the identified information for providing an audio-visual virtual assistance to the user by converting the consolidated historical learning variables into a speech output and spontaneously synchronizing it with the said virtual animated character;
f. guiding the user intuitively to one or more locations of the identified relevant information on a first display frame; and
g. training the said virtual animated character to spontaneously initiate a planar movement based on a contextually determined a one or more travel paths thereon the display and semantically positioning the virtual animated character at one or more relevant locations on the first and on a each subsequent display frame.

2. The method as claimed in claim 1, wherein the virtual animated character is a pre-designed computer generated human model adapted to interactively display one or more contextual gestures relevant to the user input and the consolidated historical learned variable.

3. The method as claimed in claim 1, wherein the user is allowed to input the query in a text format, audio format or combination thereof.

4. The method of claimed in claim 1, wherein an interactive interaction of the virtual animated character is effected for the each consolidated context by providing intelligibility to identified relevant text and converted speech using a resource description framework and a web ontology language of a semantic web technology to describe the information in subject-predicate-object format.

5. A system for assisting a user with an intuitively responsive virtual animated character to a one or more queries of the user, wherein the system comprises of:
a. a remote web server adapted to invoke and render one or more queried information on a plurality of communicatively coupled disparate communication devices, each device accessible to at least one user through a display interactivity control for facilitating assistance to the user;
b. an input processor, embedded into the remote web server, configured to receive an input query from one or more user communication devices in a first format and convert the said query in to a second format accessible;
c. a data processing unit configured to process the query to generate a response to the said query, the data processing unit comprising of:
i. an expert system coupled with a knowledge database adapted to store historical knowledge;
ii. a rule engine coupled with a behavior database, the behavior database configured to store a plurality of predefined gestures for the character and the rule engine configured to select at least one suitable gesture with one or more contexts associated therewith the query;
d. an input means configured on each communication device for receiving the user query; and
e. the display interactivity control configured to facilitate assistance to the user by through instantaneous presentation of virtual animated character suggesting at least one location on the said display relevant to the identified information, the, the said virtual animated character adapted to intuitively guide the user by physically moving to the said specific location of the identified relevant information by traversing a path.

6. The system as claimed in claim 5, wherein the user is allowed to input the query in a text format, audio format or combination thereof.

7. The system as claimed in claim 5, wherein the input means is a keyboard, a touch pad, a speech sensor or combination thereof.
